(19) United States
(12) Patent Application Publication
(10) Pub. No.: US 2019/0297253 A1
(43) Pub. Date: Sep. 26, 2019

(54) IMAGING DEVICE AND IMAGING SYSTEM

(71) Applicant: HONDA MOTOR CO., LTD., Tokyo (JP)

(72) Inventor: Hidekazu SHINTANI, WAKO-SHI (JP)

(21) Appl. No.: 16/360,079

(22) Filed: Mar. 21, 2019

(30) Foreign Application Priority Data
Mar. 22, 2018 (JP) 2018-054597

(51) Int. Cl. H04N 5/232; H04N 7/18

(52) U.S. Cl. CPC H04N 5/23222; H04N 7/188

(57) ABSTRACT

An imaging device takes an image with a camera when an imaging position resides within a given range defined by a travelling position of a mobile object as a reference position and an evaluation of an image taken at the imaging position is equal to or greater than a given value.

### CROSS-REFERENCE TO RELATED APPLICATION

This application is based upon and claims the benefit of priority from Japanese Patent Application No. 2018-054597 filed on Mar. 22, 2018, the contents of which are incorporated herein by reference.

### BACKGROUND OF THE INVENTION

### Field of the Invention

The present invention relates to an imaging device provided on a mobile object, and an imaging system including the imaging device and a server provided outside of the mobile object.

### Description of the Related Art

Japanese Laid-Open Patent Publication No. 2009-246503 discloses a device that stores images taken by an onboard camera for a certain time length by being triggered by occurrence of a given event, e.g., a steering operation or the like. Although not disclosed in Japanese Laid-Open Patent Publication No. 2009-246503, the device of Japanese Laid-Open Patent Publication No. 2009-246503 can be utilized to save images of scenes taken by an onboard camera. In this case, the user can save the images of scenes taken by the onboard camera by performing a steering operation etc. with desired timing.

Japanese Laid-Open Patent Publication No. 2017-117082 discloses a device that receives, from a server that provides a social networking service, information about photographs associated with the places where they were taken and information about evaluations of the photographs made by third parties, and displays photographs with high third-party evaluations in an enlarged manner at the places on a map where they were taken.

### SUMMARY OF THE INVENTION

Whether good images are obtained is determined by the conditions under which they are taken, and greatly affected by the experience of the person who takes the images, and therefore a little experienced person tends to fail in taking good images or miss chances of taking good images. On the other hand, good images may be obtained due to a series of coincidences, and even a highly experienced person may miss good chances.

The present invention has been made considering such problems, and an object of the present invention is to provide an imaging device and an imaging system that are capable of taking good images without effort irrespective of the experience of the person who takes the images.

According to a first aspect of the present invention, an imaging device provided on a mobile object includes:

a positioning unit configured to measure a travelling position of the mobile object;

an information obtaining unit configured to obtain image-related information including positional information indicating an imaging position at which an image was taken, and evaluation information indicating an evaluation of the image that was taken at the imaging position;

an imaging decision unit configured to make a decision to take an image when the imaging position resides within a given range defined by the travelling position as a reference position and the evaluation of the image taken at the imaging position is equal to or greater than a given value; and

an imaging unit configured to take an image of an interior or exterior of the mobile object in accordance with a result of the decision made by the imaging decision unit.

According to the configuration above, an image of the interior or exterior of the mobile object is automatically captured when the mobile object is positioned near the imaging position of an image with a high reputation, so that a new image close to the image with high reputation can be captured. As a result, it is possible to take a good new image without effort, irrespective of the experience of the person who takes the image.

In the first aspect of the present invention,

the image-related information may further include condition information indicating an imaging condition at the time when the image was taken, and

the imaging decision unit may be configured to take an image when a difference between the imaging condition at the travelling position and the imaging condition at the time when the image was taken at the imaging position is within a given difference.

According to the configuration above, an image of the interior or exterior of the mobile object is automatically taken when a difference between the imaging condition at the travelling position and the imaging condition at the time when the image was taken at the imaging position is within a given difference, so that a new image further closer to the image with high reputation can be obtained.

In the first aspect of the present invention,

the imaging condition may be whether the image was taken by a camera that is mounted on a vehicle.

According to the configuration above, an image can be taken by a camera mounted on a vehicle, so that the user does not have to prepare a camera.

In the first aspect of the present invention,

the imaging decision unit may be configured to obtain route information indicating a planned route of the mobile object and decide to adjust a setting of the imaging unit to the imaging condition indicated by the condition information when the imaging position is contained in the planned route, and

the imaging unit may be configured to adjust the setting to the imaging condition in accordance with a result of the decision made by the imaging decision unit.

According to the configuration above, it is possible to previously adjust the setting of the imaging unit to the imaging condition before the mobile object reaches a vicinity of the imaging position. It is therefore possible to prevent the inconvenience that good timing of taking an image is missed because adjusting the setting takes time.

According to a second aspect of the present invention,

an imaging system includes an imaging device provided on a mobile object and a server provided outside of the mobile object, and the imaging device and the server send and receive information to and from each other.

The server includes a server storage unit configured to store image-related information including positional information indicating an imaging position at which an image was taken, and evaluation information indicating an evaluation of the image that was taken at the imaging position.

The imaging device includes:

an information obtaining unit configured to obtain the image-related information from the server storage unit;

a positioning unit configured to measure a travelling position of the mobile object;

an imaging decision unit configured to make a decision to take an image when the imaging position resides within a given range defined by the travelling position as a reference position and the evaluation of the image taken at the imaging position is equal to or greater than a given value; and

an imaging unit configured to take an image of an interior or exterior of the mobile object in accordance with a result of the decision made by the imaging decision unit.

According to the configuration above, an image of the interior or exterior of the mobile object is automatically taken when the mobile object is positioned near the imaging position of an image with a high reputation, so that a new image close to the image with high reputation can be obtained. As a result, it is possible to take a good new image without effort, irrespective of the experience of the person who takes the image.

According to the present invention, it is possible to take good new images without effort irrespective of the experience of the person who takes the images.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a configuration diagram of an imaging system according to an embodiment;

FIG. 2 is a diagram used to explain image-related information;

FIG. 3 is a diagram showing a screen of a communication terminal; and

FIG. 4 is a flowchart of imaging processing performed by an imaging device.

### DESCRIPTION OF THE PREFERRED EMBODIMENTS

The imaging device and imaging system according to the present invention will be described in detail below in conjunction with preferred embodiments with reference to the accompanying drawings.

### 1. Configuration of Imaging System 10

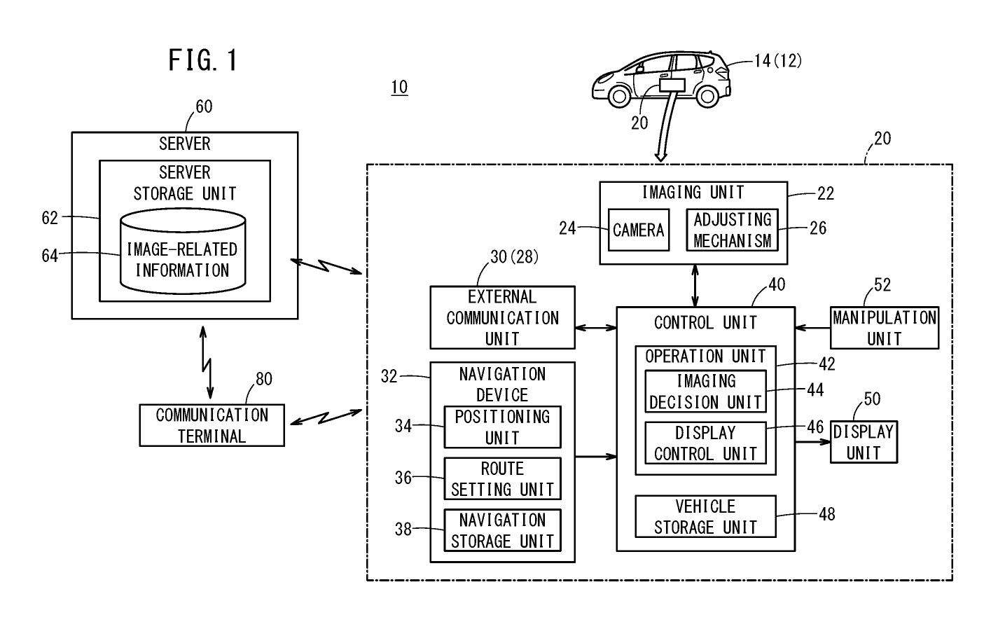

The configuration of an imaging system 10 according to this embodiment will be described referring to FIG. 1. In this embodiment, a mobile object 12 is a vehicle 14. The imaging system 10 includes an imaging device 20 provided on the vehicle 14, a server 60 provided outside of the vehicle 14, and a communication terminal 80.

### 1.1. Imaging Device 20

The imaging device 20 includes an imaging unit 22, an external communication unit 30, a navigation device 32, a control unit 40, a display unit 50, and a manipulation unit 52.

The imaging unit 22 includes a camera 24 and an adjusting mechanism 26. The camera 24 is an onboard camera that is mounted in the interior of the vehicle 14 and whose lens is directed to the exterior or interior of the vehicle 14. That is to say, the camera 24 captures images of the exterior or interior of the vehicle 14. For example, the camera 24 can be a dashboard camera or an onboard camera employed on a driver assistance vehicle or autonomous vehicle. In place of such an onboard camera, a camera provided in the communication terminal 80 of an occupant can be used. The adjusting mechanism 26 is attached in the interior of the vehicle 14 and configured to support the camera 24 and adjust the attitude of the camera 24. The adjusting mechanism 26 includes one or more actuators and adjusts directions of the camera 24 in horizontal and vertical directions.

The external communication unit 30 is a communication interface configured to perform wireless communications. The external communication unit 30 sends and receives information to and from the server 60 and the communication terminal 80 through a communication network including a telephone line, for example. In this embodiment, the external communication unit 30 functions as an information obtaining unit 28 that is configured to obtain image-related information 64 from the server 60. Also, the external communication unit 30 can transfer the image-related information 64 to the server 60. The image-related information 64 will be described later in [2. Image-related Information].

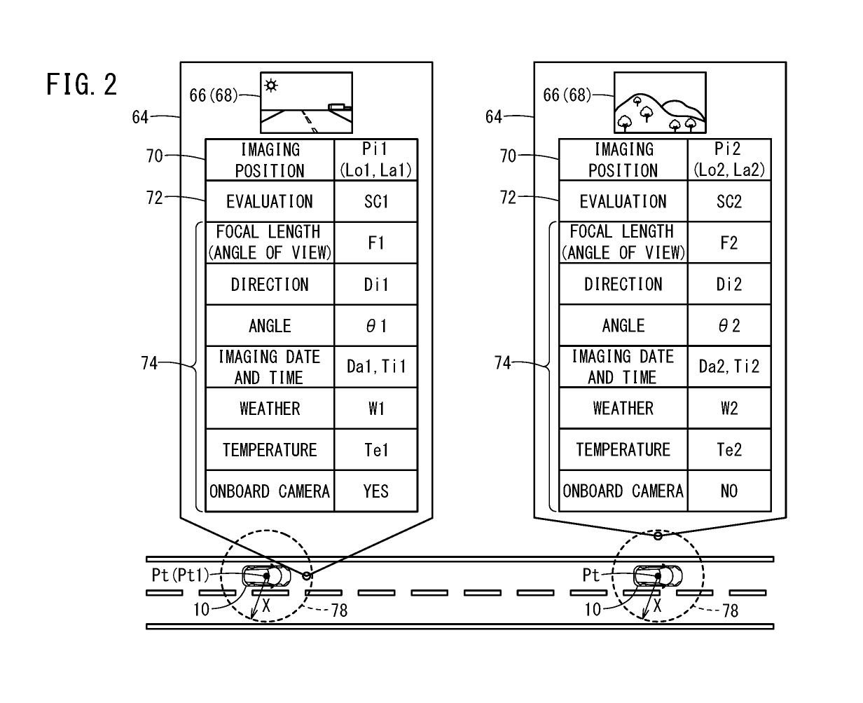

The navigation device 32 functions as a positioning unit 34 and a route setting unit 36 by a processor, such as a CPU, executing programs. The positioning unit 34 measures a travelling position Pt (FIG. 2) of the vehicle 14 by satellite navigation or self-contained navigation. The travelling position Pt includes a stop position of the vehicle 14. The route setting unit 36 sets a planned route of the vehicle 14 from the travelling position Pt to a destination. The navigation device 32 further includes a navigation storage unit 38 for storing geographical information.

The control unit 40 is an electronic control unit (ECU) including an operation portion 42 and a vehicle storage unit 48 that are integrated together. The operation portion 42 is, for example, a processor having a CPU etc. The operation portion 42 realizes various functions by executing programs stored in the vehicle storage unit 48. In this embodiment, the operation portion 42 functions as an imaging decision unit 44 and a display control unit 46. The operation portion 42 receives input information from the imaging unit 22, external communication unit 30, navigation device 32, and manipulation unit 52, and outputs information to the imaging unit 22, external communication unit 30, and display unit 50. The vehicle storage unit 48 is composed of RAM and ROM, etc.

The display unit 50 has a screen to display new images captured by the imaging unit 22. The manipulation unit 52 is a human-machine interface (e.g., a touch panel). The manipulation unit 52 outputs to the operation portion 42 information corresponding to operations performed by the occupant.

### 1.2. Server 60

The server 60 is managed by a service provider that offers the service of providing images 68 (FIG. 2). The server 60 includes a server storage unit 62 for storing the image-related information 64, and a processor such as a CPU and a communication interface for performing external communications (not shown). The server storage unit 62 is composed of RAM and ROM, etc. The server storage unit 62 has a database constructed therein and the image-related information 64 is stored therein.

### 1.3. Communication Terminal 80

The communication terminal 80 is a device such as a smartphone, tablet terminal, personal computer, or the like, which is capable of sending and receiving information to and from the server 60 through a communication network including a telephone line, for example, and also capable of capturing or displaying images. It may be a camera having a communication function.

### 2. Image-Related Information

The imaging device 20 and the communication terminal 80 register the image-related information 64 in the server 60. The server 60 provides the registered image-related information 64 to the imaging device 20 or communication terminal 80. The image-related information 64 will now be described referring to FIG. 2.

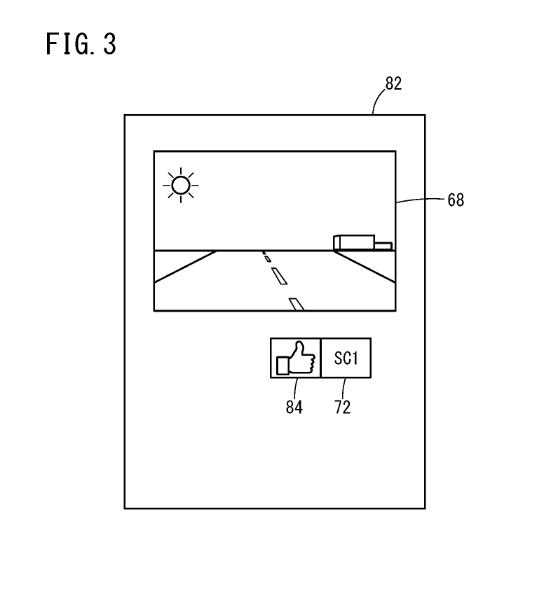

The image-related information 64 includes image information 66, positional information 70, evaluation information 72, and condition information 74. The image information 66 is data that represents an image 68 that was captured by the camera 24 of the imaging unit 22, or the communication terminal 80, or the like. The positional information 70 is data that indicates an imaging position Pi (longitude Lo, latitude La) at which the image 68 was taken. The evaluation information 72 is data that indicates an evaluation (evaluation score) SC of the image 68. The evaluation SC is determined by the user of the communication terminal 80. For example, as shown in FIG. 3, a screen 82 of the communication terminal 80 that receives the image providing service displays the image 68 represented by the image information 66 stored in the server storage unit 62 and also displays a support button 84. When the user presses the support button 84, the evaluation SC of the evaluation information 72 is increased.

The condition information 74 is data that indicates imaging conditions under which the image 68 was taken. The imaging conditions include conditions such as a focal length F (angle of view) of the camera 24 (or the camera of the communication terminal 80) that captured the image 68, a direction Di in which the optical axis of the camera 24 is directed, a vertical-direction angle θ of the camera 24, imaging date and time Da and Ti, weather W at the time of imaging, a temperature Te at the time of imaging, information indicating whether or not the camera was an onboard camera, and so on.

### 3. Operations of Imaging System 10

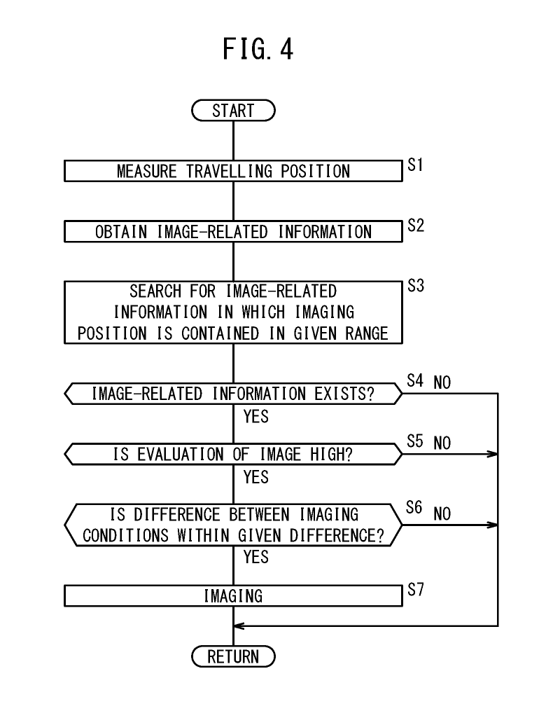

Operations of the imaging system 10 and the imaging device 20 according to this embodiment will be described referring to FIG. 4. The processing illustrated in FIG. 4 is repeatedly performed at given time intervals while the electric system of the vehicle 14 is operating.

At step S1, the positioning unit 34 measures the travelling position Pt (longitude Lo, latitude La) of the vehicle 14. The positioning unit 34 outputs information indicating the travelling position Pt to the operation portion 42.

At step S2, the external communication unit 30 obtains the image-related information 64 from the server storage unit 62. At this time, the external communication unit 30 may obtain all of the image-related information 64 stored in the server storage unit 62, or may obtain image-related information 64 concerning a partial area, e.g., an area around the travelling position Pt of the vehicle 14. When all image-related information 64 is obtained, it is not necessary to perform step S2 in the following processing. The image-related information 64 is temporarily stored in the vehicle storage unit 48.

At step S3, the imaging decision unit 44 searches for image-related information 64 in which the imaging position Pi is contained in a given range 78 defined by the travelling position Pt as a reference position. At this time, the imaging decision unit 44 sets, as the given range 78, a range within a given distance X around the travelling position Pt of the vehicle 14. Then, the imaging decision unit 44 searches the image-related information 64 stored in the vehicle storage unit 48, for image-related information 64 in which the imaging position Pi is contained within the given range 78.

If image-related information 64 containing the imaging position Pi within the given range 78 is present (step S4: YES), the process proceeds to step S5. On the other hand, if image-related information 64 containing the imaging position Pi within the given range 78 is absent (step S4: NO), the process is once terminated.

When the process moves from step S4 to step S5, the imaging decision unit 44 decides whether the evaluation SC of the image 68 that was taken within the given range 78 is high or not. For example, at the travelling position Pt1 shown in FIG. 2, the imaging decision unit 44 decides whether the evaluation SC1 indicated by the evaluation information 72 contained in the retrieved image-related information 64 is high or low. The vehicle storage unit 48 previously stores a given value SCth as a threshold for deciding whether the evaluation SC1 is high or low. If the evaluation SC1 is larger than the given value SCth, the imaging decision unit 44 decides that the evaluation SC of the image 68 is high (step S5: YES). In this case, the process proceeds to step S6. On the other hand, if the evaluation SC1 is equal to or less than the given value SCth, the imaging decision unit 44 decides that the evaluation SC of the image 68 is low (step S5: NO). In this case, the process is once terminated.

When the process moves from step S5 to step S6, the imaging decision unit 44 decides whether a difference between the imaging conditions of the image 68 that was taken within the given range 78 and the latest (present) imaging conditions is within a given difference. In other words, “whether the difference is within a given difference or not” can be construed as “whether the difference satisfies a given condition”. At this time, the imaging decision unit 44 compares the imaging conditions contained in the retrieved image-related information 64 and the latest imaging conditions. As has been explained in [2. Image-related Information] above, the imaging conditions include conditions such as the focal length F, the direction Di in which the optical axis of the camera 24 is directed, the vertical-direction angle θ of the camera 24, the imaging date and time Da and Ti, the weather W at the time of imaging, the temperature Te at the time of imaging, information indicating whether the camera was an onboard camera, and the like.

The imaging decision unit 44 obtains information indicating the focal length F from the vehicle storage unit 48. For example, at the travelling position Pt1 shown in FIG. 2, the imaging decision unit 44 decides whether a difference between the focal length F1 contained in the image-related information 64 and the latest focal length F is within a given difference that is stored in the vehicle storage unit 48.

The imaging decision unit 44 calculates information indicating the direction Di based on the direction of optical axis (an initial set value) previously stored in the vehicle storage unit 48, the amount of adjustment of the adjusting mechanism 26, and the direction of the vehicle 14 measured by the positioning unit 34. For example, at the travelling position Pt1 shown in FIG. 2, the imaging decision unit 44 decides whether a difference between the direction Di1 contained in the image-related information 64 and the latest direction Di is within a given difference that is stored in the vehicle storage unit 48.

The imaging decision unit 44 calculates information indicating the angle θ based on the angle of optical axis (an initial set value) previously stored in the vehicle storage unit 48, the amount of adjustment of the adjusting mechanism 26, and a value detected by an inclination sensor not shown. For example, at the travelling position Pt1 shown in FIG. 2, the imaging decision unit 44 decides whether a difference between the angle θ1 contained in the image-related information 64 and the latest angle θ is within a given difference that is stored in the vehicle storage unit 48.

The imaging decision unit 44 obtains information indicating the imaging date and time, Da and Ti, from system date and system time. For example, at the travelling position Pt1 shown in FIG. 2, the imaging decision unit 44 decides whether a difference between the imaging date and time, Da1 and Ti1, contained in the image-related information 64 and the latest imaging date and time, Da and Ti, is within a given difference that is stored in the vehicle storage unit 48.

The imaging decision unit 44 determines information indicating the weather W and temperature Te based on values detected by a weather sensor (a solar sensor, raindrop sensor) and a temperature sensor (not shown), or based on weather information and temperature information received by a receiver (not shown). For example, at the travelling position Pt1 shown in FIG. 2, the imaging decision unit 44 decides whether a difference between the weather W1 and temperature Tel contained in the image-related information 64 and the latest weather W and temperature Te is within a given difference that is stored in the vehicle storage unit 48. For example, if the weather W1 contained in the image-related information 64 and the latest weather W2 are the same, the imaging decision unit 44 decides that the difference is within the given difference or satisfies the given condition; if they are different, the imaging decision unit 44 decides that the difference exceeds the given difference or does not satisfy the given condition.

The imaging decision unit 44 obtains information indicating whether the camera is an onboard camera from the vehicle storage unit 48. For example, at the travelling position Pt1 shown in FIG. 2, the imaging decision unit 44 decides that the imaging condition is within a given difference or satisfies a given condition if the image-related information 64 contains information indicating that the camera is an onboard camera; if the image-related information 64 does not contain information indicating that the camera is an onboard camera, the imaging decision unit 44 decides that the imaging condition exceeds the given difference or does not satisfy the given condition.

At step S6, the imaging decision unit 44 makes a comparison about predetermined condition(s) among the multiple imaging conditions described above. The comparison may be made about a single imaging condition or multiple imaging conditions. When the difference between the imaging conditions is within a given difference (step S6: YES), the process proceeds to step S7. On the other hand, if the difference between the imaging conditions exceeds the given difference (step S6: NO), the process is once terminated.

When the process moves from step S6 to step S7, the imaging decision unit 44 decides to conduct imaging. At this time, the imaging decision unit 44 outputs a signal indicating an instruction for capturing an image to the imaging unit 22. Further, for example, at the travelling position Pt1 in FIG. 2, the imaging decision unit 44 may output a signal indicating an instruction for adjustment to adjust the focal length F, direction Di, and angle θ to the focal length F1, direction Di1, and angle θ1. When the adjustment instruction is outputted, the camera 24 adjusts the focal length F. Further, the adjusting mechanism 26 adjusts the direction Di and angle θ of the camera 24. Then, after the adjustment has been made, the camera 24 performs imaging.

The new image obtained by imaging is sent to the control unit 40. The display control unit 46 causes the new image to be displayed on the display unit 50. Further, the display control unit 46 generates image-related information 64 by correlating the image information 66 representing the new image, the positional information 70 indicating the travelling position Pt at the time when the new image was taken, and the condition information 74 indicating individual imaging conditions. The image-related information 64 is stored in the vehicle storage unit 48. Then, in response to a transmission instruction outputted from the manipulation unit 52, the display control unit 46 gives a transfer instruction to the external communication unit 30. In response to the transfer instruction, the external communication unit 30 transfers the image-related information 64 to the server 60. The server 60 registers the image-related information 64 in the server storage unit 62. At this time, the image information 66 representing the new image may be transferred to the communication terminal 80 that the occupant possesses.

### 4. Examples of Modifications and Applications

### (1) Example 1

The imaging conditions, or the focal length F, direction Di, and angle θ of the camera 24 herein, can be adjusted in advance. The imaging decision unit 44 obtains route information indicating a planned route of the vehicle 14 from the navigation device 32, and generates a route region in which a given distance X is added on both sides of the width direction of the planned route. Then, the imaging decision unit 44 decides whether there is image-related information 64 in which a position in the route region is the imaging position Pi, from among the image-related information 64 stored in the vehicle storage unit 48. When such image-related information 64 is present, an adjustment signal is outputted to instruct to adjust the settings of the imaging unit 22 to the imaging conditions indicated by the condition information 74 corresponding to that imaging position Pi, i.e., the focal length F, direction Di, and angle θ.

### (2) Example 2

The processing of step S6 shown in FIG. 4 may be omitted. That is to say, the decision as to whether to take an image may be made simply on the basis of the comparison between the travelling position Pt and imaging position Pi and the level of the evaluation SC.

### (3) Example 3

The adjusting mechanism 26 for adjusting the optical axis of the camera 24 may be absent. In this case, the processing of step S7 shown in FIG. 4 performs imaging after the focal length F has been adjusted.

### (4) Example 4

The imaging conditions may include other conditions. For example, the moving speed and acceleration of the camera 24, i.e., the travelling speed, acceleration, etc. of the vehicle 14, may be included.

### (5) Example 5

The imaging conditions may be informed to the occupant when the vehicle 14 comes close to the imaging position Pi. At this time, the display control unit 46 may be configured to output a notification instruction to the display unit 50, or output a notification instruction to an acoustic instrument not shown. Further, when the communication terminal 80 that the occupant possesses is used as the camera 24, a notification instruction may be outputted to the communication terminal 80.

### (6) Example 6

In the above-described embodiment, the mobile object 12 is the vehicle 14. However, the mobile object 12 need not necessarily be the vehicle 14 but may be, for example, a railway vehicle.

### 5. Points of Embodiment

### 5.1. Points of Imaging Device 20

An imaging device 20 includes: a positioning unit 34 configured to measure a travelling position Pt of a mobile object 12; an information obtaining unit 28 (external communication unit 30) configured to obtain image-related information 64 including positional information 70 indicating an imaging position Pi at which an image 68 was taken, and evaluation information 72 indicating an evaluation SC of the image 68 that was taken at the imaging position Pi; an imaging decision unit 44 configured to make a decision to take an image when the imaging position Pi resides within a given range 78 defined by the travelling position Pt as a reference position and the evaluation SC of the image 68 taken at the imaging position Pi is equal to or greater than a given value SCth; and an imaging unit 22 configured to take an image of an interior or exterior of the mobile object 12 in accordance with a result of the decision made by the imaging decision unit 44.

According to the configuration above, an image of the interior or exterior of the mobile object 12 is automatically taken when the mobile object 12 is positioned near the imaging position Pi of an image 68 with a high reputation SC, so that a new image close to the image 68 with the high reputation SC can be obtained. As a result, it is possible to take a good new image without effort, irrespective of the experience of the person who takes the image.

The image-related information 64 may further include condition information 74 indicating an imaging condition at a time when the image 68 was taken. The imaging decision unit 44 may be configured to take an image further when a difference between the imaging condition at the travelling position Pt and the imaging condition at the time when the image 68 was taken at the imaging position Pi is within a given difference.

According to the configuration above, an image of the inside or outside of the mobile object 12 is automatically taken when a difference between the imaging condition at the travelling position Pt and the imaging condition at the time when the image 68 was taken at the imaging position Pi is within a given difference, so that a new image further closer to the image 68 of the high reputation SC can be obtained.

The imaging condition may be whether the image was taken by a camera 24 that is mounted on a vehicle 14.

According to the configuration above, an image can be taken by the camera 24 mounted on the vehicle 14, so that the user does not have to prepare a camera 24.

The imaging decision unit 44 may be configured to obtain route information indicating a planned route of the mobile object 12 and decide to adjust a setting of the imaging unit 22 to the imaging condition indicated by the condition information 74 when the imaging position Pi is contained in the planned route. The imaging unit 22 may be configured to adjust the setting to the imaging condition in accordance with a result of the decision made by the imaging decision unit 44.

According to the configuration above, it is possible to previously adjust the setting of the imaging unit 22 to the imaging condition before the mobile object 12 reaches a vicinity of the imaging position Pi. It is thus possible to prevent the inconvenience that good timing of taking an image is missed because adjusting the setting takes time.

Further, according to this embodiment, the image-related information 64 is generated in which image information 66 representing a new image taken by the camera 24, positional information 70 indicating the imaging position Pi of the new image, and condition information 74 indicating the imaging condition at the time when the new image was taken are correlated together, and the image-related information 64 is saved in a vehicle storage unit 48. Accordingly, the user of the vehicle 14 can easily reproduce the imaging condition in the past, and can perform time-lapse imaging.

Also, suitable condition information 74 can be collected with lesser effort when the number of pieces of the image-related information 64 that the external communication unit 30 obtains becomes larger. Accordingly, there is a possibility that imaging conditions that even a highly experienced user has missed can be collected.

### 5.2. Points of Imaging System 10

An imaging system 10 includes an imaging device 20 provided on a mobile object 12 and a server 60 provided outside of the mobile object 12. The imaging device 20 and the server 60 send and receive information to and from each other. The server 60 includes a server storage unit 62 configured to store image-related information 64 including positional information 70 indicating an imaging position Pi at which an image 68 was taken, and evaluation information 72 indicating an evaluation SC of the image 68 that was taken at the imaging position Pi. The imaging device 20 includes: an information obtaining unit 28 configured to obtain the image-related information 64 from the server storage unit 62; a positioning unit 34 configured to measure a travelling position Pt of the mobile object 12; an imaging decision unit 44 configured to make a decision to take an image when the imaging position Pi resides within a given range 78 defined by the travelling position Pt as a reference position and the evaluation SC of the image 68 taken at the imaging position Pi is equal to or greater than a given value SCth; and an imaging unit 22 configured to take an image of an interior or exterior of the mobile object 12 in accordance with a result of the decision made by the imaging decision unit 44.

According to the configuration above, an image of the interior or exterior of the mobile object 12 is automatically taken when the mobile object 12 is located near the imaging position Pi of an image 68 with a high reputation SC, so that a new image close to the image 68 with the high reputation SC can be obtained. As a result, it is possible to take a good new image without effort, irrespective of the experience of the person who takes the image.

The imaging device and imaging system according to the present invention are not limited to the above-described embodiments and can of course take various configurations without departing from the scope of the present invention.

What is claimed is:

1. An imaging device provided on a mobile object, comprising:
a positioning unit configured to measure a travelling position of the mobile object;
an information obtaining unit configured to obtain image-related information including positional information indicating an imaging position at which an image was taken, and evaluation information indicating an evaluation of the image that was taken at the imaging position;
an imaging decision unit configured to make a decision to take an image when the imaging position resides within a given range defined by the travelling position as a reference position and the evaluation of the image taken at the imaging position is equal to or greater than a given value; and
an imaging unit configured to take an image of an interior or exterior of the mobile object in accordance with a result of the decision made by the imaging decision unit.

2. The imaging device according to claim 1, wherein
the image-related information further includes condition information indicating an imaging condition at a time when the image was taken, and
the imaging decision unit is configured to take an image further when a difference between the imaging condition at the travelling position and the imaging condition at the time when the image was taken at the imaging position is within a given difference.

3. The imaging device according to claim 2, wherein the imaging condition is whether the image was taken by a camera that is mounted on a vehicle.

4. The imaging device according to claim 2, wherein
the imaging decision unit is configured to obtain route information indicating a planned route of the mobile object and decide to adjust a setting of the imaging unit to the imaging condition indicated by the condition information when the imaging position is contained in the planned route, and
the imaging unit is configured to adjust the setting to the imaging condition in accordance with a result of the decision made by the imaging decision unit.

5. An imaging system comprising an imaging device provided on a mobile object and a server provided outside of the mobile object, the imaging device and the server sending and receiving information to and from each other,
the server including a server storage unit configured to store image-related information including positional information indicating an imaging position at which an image was taken, and evaluation information indicating an evaluation of the image that was taken at the imaging position, and
the imaging device including:
an information obtaining unit configured to obtain the image-related information from the server storage unit;
a positioning unit configured to measure a travelling position of the mobile object;
an imaging decision unit configured to make a decision to take an image when the imaging position resides within a given range defined by the travelling position as a reference position and the evaluation of the image taken at the imaging position is equal to or greater than a given value; and
an imaging unit configured to take an image of an interior or exterior of the mobile object in accordance with a result of the decision made by the imaging decision unit.
